(19) United States
(12) Patent Application Publication
(10) Pub. No.: US 2008/0281710 A1
(43) Pub. Date: Nov. 13, 2008

(54) Youth Based Social Networking

(76) Inventor: Mary Kay Hoal, Davis, CA (US)

Correspondence Address: BULLIVANT HOUSER BAILEY PC, 1415 L STREET, SUITE 1000, SACRAMENTO, CA, 95814, US

(21) Appl. No.: 12/118,709

(22) Filed: May 10, 2008

Related U.S. Application Data
(60) Provisional application No. 60/928,753, filed on May 10, 2007.

(51) Int. Cl. G06Q 30/00; G06F 17/30; G06F 7/06

(52) U.S. Cl. 705/14; 707/10; 707/3; 707/E17.032; 707/E17.014

(57) ABSTRACT

The invention provides a method for managing an online social network, the method comprising: establishing criteria for membership in a social network; receiving a request to participate in the social network; obtaining information about the requester; verifying the actual identify of the requester; and determining the eligibility of the requester to participate in the social network based on the established criteria.

### CROSS REFERENCE TO RELATED APPLICATIONS

This application claims priority to, and the benefit of, U.S. Provisional Application No. 60/928,753, filed May 10, 2007 and entitled “Social Networking Site”, which is hereby incorporated by reference in its entirety.

### BACKGROUND OF THE INVENTION

1. Field of the Invention

This invention generally relates to a social networking management system (“SNS”), and more particularly, to a secure site for supporting online social networking by young people.

2. Description of Related Art

The Internet continues to make available ever-increasing amounts of information commonly stored in databases and accessed through a variety of terminals (e.g., notebook computers, cellular telephones, personal data assistants (PDAs), smart-phones and other similar communication devices). Users are becoming more mobile, and hence, more reliant upon information accessible via the Internet which is frequently used to chat, socialize and communicate with friends and family.

There are many factors specific to the nature of online communications that may affect the experience especially for users between the ages of 9 and 18. These users require special attention to prohibit improper access by cyber predators (e.g., criminals, pedophiles, bullies) or inappropriate content.

While recent technological advancements, including the Internet, intranets, email, and mobile communication devices, newer and more advanced forms of communication have become available for trying to keep large groups of people informed about common interests, these systems do not contemplate a secure environment for children with age-appropriate content. The current social networking environments fail to engage security mechanisms to proactively screen out potential harmful users that have behavioral tendencies that target children as prey (e.g., comments or images suggest they may involve incest, pedophilia, bullying or other inappropriate content).

A recent report demonstrates the risk to teenagers on social networking environments that do not provide a safe and secure place for teens (ages 13-18) and tweens (ages 9-12) to cyberhang. (See, e.g., Paulson, Wired, Jan. 17, 2008, MySpace Bug Leaks ‘Private’ Teen Photos to Voyeurs.) Another report from Researchers at the Crimes Against Children Research Center at the University of New Hampshire, found that most online sex offenders are looking for teens, not kids. (“Online ‘Predators’ and Their Victims: Myths, Realities, and Implications for Prevention,” the American Psychological Association's journal, American Psychologist, February/March 2008.) Similarly, “[a]fter an examination of about one third of the data, there are 744 sex offenders with MySpace profiles. Of those, 497 are registered for sex crimes against children. At least 243 of the 497 have convictions in 2000 or later.” (See, “Busted on MySpace” by Kevin Poulsen, Wired, October 2006.) Currently, there are approximately 80 social networking websites, 10 of which attract pre-teen (“tween”) and teen users.

U.S. Pat. No. 7,275,102, to Yeager, “Trust mechanisms for a peer-to-peer network computing platform”, describes a decentralized, distributed trust mechanism that may be used in various networking platforms including peer-to-peer platforms, to implement trust relationships between and among peers and to implement trust relationships between peers and content and data (codat). Protocols and methods may be provided for determining, disseminating and updating trust. For participating peers, trust may be biased towards data relevance. Trust may have multiple components or factors, which may include peer confidence, codat confidence and risk components, and embodiments may provide for the inclusion of factors of trust based on a peer group's interests and/or group content relevance. Embodiments may be used for a variety of applications in which trust may be based on the norm for age-appropriate social interaction between participating peers.

United States Patent Application No. 20080098313, titled “System and Method for Developing and Managing Group Social Networks”, describes a system and method for facilitating the configuration and management of events within a social networking system is disclosed. The system enables members of similar or different geographic region and/or like interests, hobbies, social status, relationship status, family status, etc. to interact with the system to view activities, register to participate in activities, and schedule activities. A personalized user interface, accessible through a variety of devices (e.g., kiosks, web clients, wireless devices, desktop and/or laptop computers) enables network members to view instant messages, a personal calendar, scheduled events and activities, invitations, localized news, and the like. The personalized user interface further facilitates communications, participation in sponsored activities, and participation in scheduled activities among numerous other categories of interactive peer groups created by users according their interests.

None of the prior or currently available social networking environments have implemented systems integrated into the SNS that require age verification at registration with parental approval and verification.

None of the prior or currently available social networking environments have a function to automatically and dynamically match a user or group of users with other users or groups of users having similar interests or commonality.

The present invention addresses the disadvantages of other systems by combining and improving known technologies to create a public/private network that aids in developing a secure age-specific group social networks for children (ages 9-18) that screens out unauthorized adults and inappropriate content.

### SUMMARY OF THE INVENTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

In one aspect, the invention provides a method for managing an online social network, the method comprising: establishing criteria for membership in a social network; receiving a request to participate in the social network; obtaining information about the requester; verifying the actual identify of the requester; and determining the eligibility of the requestor to participate in the social network based on the established criteria.

The established criteria can be based on such elements as: geographic area, age, gender, hobby, interest, relationship status, family status, profession, memberships, education, financial status, race, religion, and event type.

In a preferred embodiment of the method the established criteria is an age range, more particularly, an age range restricted to youth.

In a preferred embodiment the age range is nine to eighteen.

In a different preferred embodiment the method further comprises creating a profile for an eligible first user.

In another preferred embodiment the information obtained from the requester is personal information.

In a preferred embodiment verifying the identify of the requester is based on presenting the requestor's information to an internet database.

In a further preferred embodiment the request to participate in the social network further comprises a waiver of anonymity from the requester. In a different such preferred embodiment the request to participate in the social network comprises a request for personal information about the requester.

In a preferred embodiment the personal information includes information from at least one category of: nationality, address, birth, financial, governmental, criminal, military, work and education.

In a preferred embodiment verifying the identify of the requester comprises first verifying the identity of a proxy requestor, such as a parent or guardian of a minor requester. In this preferred embodiment it is preferred to first verify the identity of the proxy, and the verified proxy verifies the identify of the minor requester.

In a preferred embodiment the verified identity of at least one of the requestor and the proxy are run through a sex-offender database. In a still preferred embodiment, the sex-offender database applies standards set forth by law for sex-offender screening, and preferably the sex-offender database qualifies as an FTC approved Safe Harbor provider under COPPA.

In another aspect, the invention provides a method for managing an online social network, the method including the steps of: a) identifying patterns associated with inappropriate user activity; a) monitoring the online actions of at least one user of the social network; b) evaluating online actions taken by the at least one user; and c) comparing the online actions to the identified patterns associated with inappropriate activity.

In a preferred embodiment a database of online actions taken by the at least one user is maintained. In a still further preferred embodiment evaluating the online actions taken by the at least one user comprises collecting data on sites visited by the at least one user, or collecting data on online interactions between the at least one user and other users.

In a preferred embodiment comparing the online actions to the identified patterns comprises applying an algorithm. In a still preferred embodiment the algorithm comprises a collaborative filtering mechanism.

In another preferred embodiment the patterns associated with inappropriate user activity are indicative of bullying activity. In a different preferred embodiment the patterns associated with inappropriate user activity are indicative of sexual predator activity.

In a preferred embodiment the method further comprises: d) blocking access to the social network by a user demonstrating patterns associated with inappropriate user activity.

In another preferred embodiment the method comprises further: d) removing a user demonstrating patterns associated with inappropriate user activity.

In a still further preferred embodiment the method comprises: d) sending a request for information to the user demonstrating patterns associated with inappropriate user activity.

In another aspect, the invention provides a method of managing an online social network for peer interactions, the method comprising: a) creating at least one sphere for users to associate over a common interest; b) identifying patterns associated with activity indicative of the common interest; c) monitoring the online actions of at least one user of the social network; d) evaluating the online actions taken by the at least one user; and e) comparing the online actions to the identified patterns associated with interest in the sphere category.

In a preferred such embodiment the patterns associated with interest in the sphere category are indicative of interest in a sphere selected from the group consisting of commercial interest, social interest, community interest, sport-related interest, arts-related interest, a hobby-related interest, and an activity-related interest.

In a preferred embodiment the method further comprises: d) sending a request for information to the user demonstrating patterns associated with interest in the sphere category.

In a different preferred embodiment the method comprises: d) sending an invitation to membership in the sphere category.

The method may also preferably include: d) sending a targeted advertisement to the user demonstrating patterns associated with interest in the sphere category.

In a further preferred embodiment the method comprises: d) awarding a scholarship to a user demonstrating strong participation in the sphere category.

In another embodiment of the invention, the invention provides for management of an online social network, the method comprising: a) identifying patterns associated with activity indicative of a commonality of interests between at least two users; b) monitoring the online actions of at least two users of the social network; c) evaluating the online actions taken by the at least two users; and d) comparing online actions to the identified patterns associated with a commonality of interests.

In a preferred such embodiment evaluating the online actions taken by the at least two users comprises collecting data on sites visited by the at least two users, and even more preferably collecting data about online interactions between the at least two users and other users of the social networking site.

In a preferred embodiment the invention comprises maintaining a database of online actions taken by the at least two users.

In a further preferred embodiment the method further comprises: d) sending a request for information to the at least two users regarding a commonality of interests.

Alternatively the method may comprise: d) sending an invitation to an online interaction between at least two users demonstrating patterns associated with a commonality of interests.

In a still further aspect, the invention provides an online social network substantially limited to youth, the network comprising: a) a computer database comprising data associating each user with information regarding age of the user; b) a computer program for determining the eligibility of the user to participate in the social network based on established criteria; c) means for collecting revenues based on access to the social network; and d) a rewards program for returning a percentage of revenues to users as rewards. Preferably, the revenues are membership fees collected from users or advertising revenues collected from advertisers on said social network.

The rewards program preferably comprises a reward selected from the group consisting of funded internships, training, mentoring programs and scholarships.

Alternatively, the rewards can be philanthropic donations selected by users, either by voting or by individual designations.

Thus, the system connects age-appropriate users with others in for the purpose of communicating and participating in similar interests, hobbies and activities. The SNS, automatically brings age-appropriate people together, who were previously unknown to one another, but who have interests in common such as geographic location, activity interests, and other personality interests.

The SNS provides children between the ages of 9 and 18 a safe interactive social networking environment that utilizes an algorithm to continually scan and analyze user behavior to identify and flag specific users having improper, inappropriate or criminal conduct. Once the suspicious user is identified, additional measures can be utilized by individuals for further analysis and investigation. If an unauthorized user is discovered, that user is prohibited from using the SNS.

The SNS also offers users opportunities to enter contests to compete for prizes and/or scholarships and/or once-in-a-lifetime opportunities to participate in educational or entrepreneurial enterprises. The SNS can scan photographs posted on the SNS to determine the age of the person or persons in the picture.

The SNS can also scan photographs and other graphic media posted on the SNS for inappropriate content (e.g., private body parts). Once discovered, the inappropriate content removed.

The SNS provides additional age restrictions for communications and interactions within the SNS by creating a default setting, unless unlocked by a parent, preventing interactions between users of greater that a four-year age difference.

The SNS provides a safe and secure virtual environment that prevents users from participating anonymously (e.g., “where anybody can't be anybody”) and by requiring parental verification and linking the user's identity to a credit card, name, address, or any additional personal information to create security through identity verification.

The SNS allows all users to create and post age-appropriate content defined by categories and subcategories, e.g., music, TV shows, movies/film, romance/dating/relationships, sports, online games, art, photography, fashion, computers 8: technology, video creation, photography, fitness, travel, meeting other boys/girls. These categories and subcategories are defined as “spheres”. Each sphere created by users must be “verified” and will not be accessible to users until verification is complete.

The SNS is implemented through the Internet, through a wireless network, over a local area network, or via any other communication or network system discussed herein or developed in the future. According to another embodiment of the invention, the features available on the device could be general features, and/or the features could be customized for a specific network.

### BRIEF DESCRIPTION OF THE DRAWINGS

FIG. 1 is an example illustrating the basic user-to-user model.

FIG. 2 is a block diagram illustrating the major system components for an exemplary system for managing a safe and secure Internet-based social networking system for children ages 9-18.

FIG. 3, illustrates a component of the SNS that functions to execute and maintain a safe and secure environment for online users ages 9-18.

FIG. 4, illustrates how a single user connected to the SNS through an SNS terminal device can connect to other users on the SNS delineated by spheres having particular interests.

FIG. 5 is a block diagram illustrating an exemplary customized user interface for a 16-year-old male user with electronic links to lists, people, events, etc.

FIG. 6 is a block diagram illustrating an exemplary customized user interface for a 16-year-old female user with electronic links to lists, people, events, etc.

FIG. 7A is a process flow diagram illustrating exemplary steps for facilitating the safety features of the invention using registration and verification steps.

FIG. 7B is a process flow diagram illustrating exemplary steps for facilitating the safety features of the invention using monitoring and investigative steps.

These and other features and advantages of this invention are described in, or are apparent from, the following detailed description of various exemplary embodiments of the apparatus and methods according to this invention.

### DETAILED DESCRIPTION OF THE INVENTION

The detailed description of exemplary embodiments describes the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In general, the invention includes a system for developing and managing social age-specific user networks for children between the ages of 9 and 18. As used herein, “social network” or similar phrases may include any grouping of two or more individuals through shared (or different) geographic regions, interests, hobbies, sporting interests, relationship status, race or religious interests, political interests, and the like, i.e., category-based spheres. The invention includes the facilitation of electronic communication over the Internet or other networking protocol, for the purpose of forming social networks, scheduling activities, joining social networks, registering to participate in activities, and/or the like.

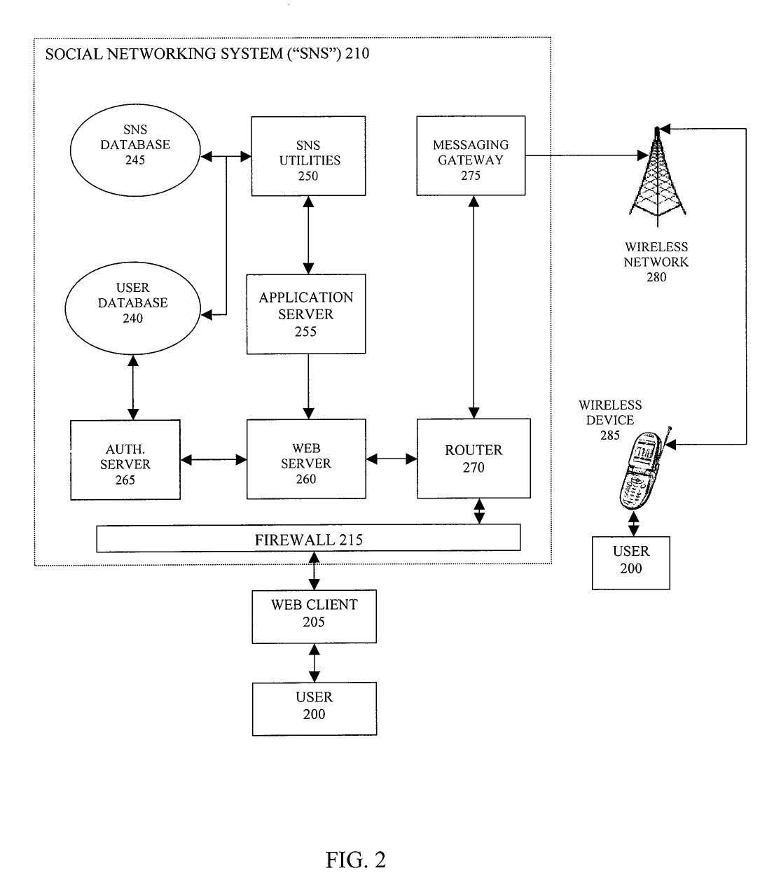

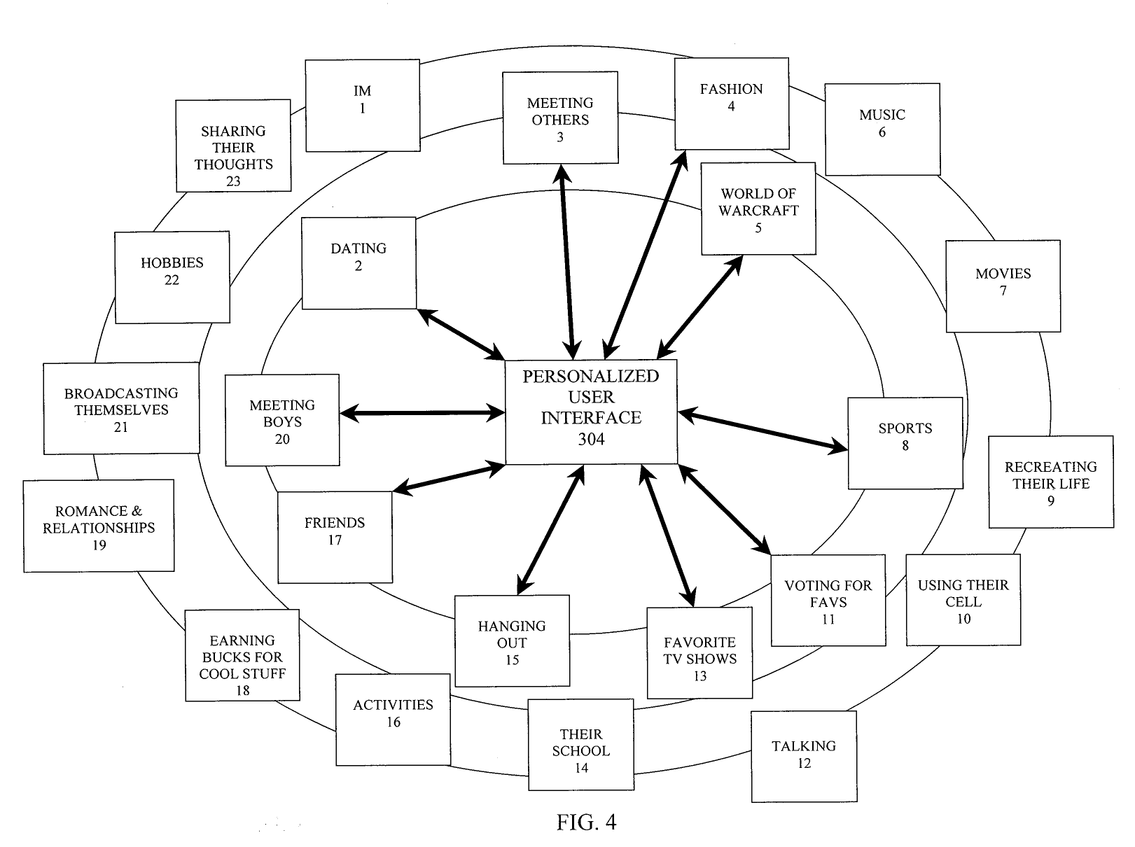

Referring to the figures, the block system diagram and process flow diagram represent mere embodiments of the invention and are not intended to limit the scope of the invention as described herein. For example, the steps recited in FIGS. 2, 3, 7A and 7B may be executed in any order and are not limited to the order presented. Furthermore, the user interface elements of FIGS. 4-6 may be presented in any arrangement and may include more or less elements than is shown.

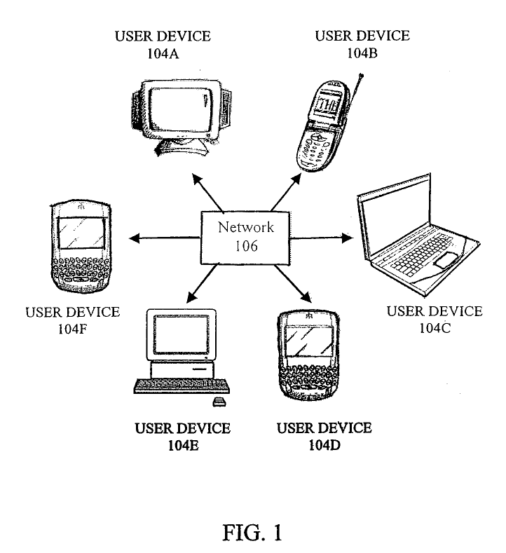

FIG. 1 shows several user devices 104 connected over the network 106 forming the SNS 210.

As depicted in FIG. 2, the Social Networking System (SNS) 210 facilitates interaction between various users and SNS utilities 250 through, in one embodiment, a web client 205 with a network connection to a web server 260 for the purposes of, for example, communicating with other users, scheduling events, viewing events, and registering to participate in future events. In various other embodiments, user 200 may interact with SNS 210 through any communication device (e.g., wireless device 285), or any other known method and/or device configured to communicate over an electronic network. As will be described in greater detail herein, such electronic networks may comprise, for example, a LAN, WAN, cellular network, satellite, radio, infrared, and the like.

SNS utilities 250 may include functional software or other computer executable systems of subsystems necessary to the function of the SNS 210 and/or necessary to enhance and/or upgrade the SNS 210 and/or to the security and safety components of the SNS 210. SNS utilities 250 may further include databases of information relating to users 200, SNS database 245, third party information, security information and functions, etc.

Web server 260 may employ an authentication server 265 in order to validate and assign proper permissions to authorized users of SNS 210. Web server 260 also employs an application server 255 to manage various applications and utilities that are utilized by SNS 210. User database 240 stores profiles, credentials and permissions specific to each user 200. In one embodiment, application server 255 interfaces with a report engine (not shown) to create pre-configured and/or ad-hoc reports representing any data elements or codats contained in the SNS database.

User 200 may include any age-appropriate registered individual which interacts with SNS 210 to communicate with other age-appropriate registered users, to plan events, schedule events, view scheduled events, register for participation, receive news updates, play streaming music, play online games, share ideas and interests, and the like. Further, approved and registered age-appropriate merchants, organizations, informational or social websites may interface with SNS 210 such that, for example, SNS 210 may provide music, TV shows, movies/film, romance/dating/relationships, sports, online games, art, photography, fashion, computers 8: technology, video creation, fitness, travel, meeting other boys/girls, weather updates, directions to events, sale of complementary products (e.g., sell athletic shoes on a page that is scheduling a cheerleading event) and/or the like. User 200 may also be an event coordinator, an event sponsor, a facilities administrator, a business owner, or any other third-party with an interest in participating with the invention in order to manage, plan, schedule, or participate in social networking activities.

In addition to the components described above, SNS 210 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include user database 240 and SNS utilities database 250, as well as any number of other databases, both internal and external to SNS 210 useful in the operation of the invention as disclosed.

As used herein, the term “network” shall include any electronic communications means which incorporates both hardware and software components of such. Communication among the parties may be accomplished through any suitable communication channels, such as, for example, a telephone network, an extranet, an intranet, Internet, point of interaction device (point of sale device, personal digital assistant (e.g., Palm Pilot®, Blackberry®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of age-appropriate goods, services or information over any network having similar functionality described herein.

In one embodiment, SNS utilities 250, or any other SNS 210 component, may interact with any number of additional computing systems and databases in order to facilitate, for example, administration, matching, security, event planning, event scheduling, registration, advertising, and etc. Computing systems and databases residing outside of SNS 210 may be administered by any other third party entity directly or indirectly involved in facilitating the disclosed system. Such third party entities may include governmental organizations, financial institutions, non-profit organizations, small businesses, corporations, and the like.

As will be appreciated by one of ordinary skill in the art, the invention may be embodied as a customization of an existing system, an add-on product, upgraded software, a standalone system (e.g., kiosk), a distributed system, a method, a data processing system, a device for data processing, and/or a computer program product. Accordingly, the invention may take the form of an entirely software embodiment, an entirely hardware embodiment, or an embodiment combining aspects of both software and hardware. Furthermore, the invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

In one embodiment, SNS 210 provides limited or restricted access for certain people or spheres, such as, for example, age-appropriate and verified users or any other verified and approved third party with an interest in, communicating with peers, scheduling and/or participating in social activates, seminars, workshops, entertainment venues, dining, and the like. User 200 may interface with SNS 210 via any communications protocol, device or method discussed herein or known in the art. In one embodiment, user 200 may interact with the invention via an Internet browser at a web client 205, and/or wireless device 285, and/or any other known method and/or device configured to communicate over an electronic network. In another embodiment, user 200 may interact with the invention by way of client PC with a LAN connection to the various components of SNS 210.

Web client 205 comprises any hardware and/or software suitably configured to facilitate input, receipt and/or review of any information related to SNS 210 or any information discussed herein. In one embodiment, a web client 205 may include a browser application installed on any device (e.g., wireless device 285), which communicates (in any manner discussed herein) with the invention via any network discussed herein. Such browser applications comprise Internet browsing software installed within a computing unit or system to conduct online transactions and communications. These computing units or systems may take the form of a computer or set of computers, although other types of computing units or systems may be used, including laptops, notebooks, hand held computers, workstations, computer-servers, main frame computers, mini-computers, PC servers, pervasive computers, network sets of computers, and/or the like. Practitioners will appreciate that web client 205, and/or wireless device 285, and/or any other known method and/or device configured to communicate over an electronic network may or may not be in direct contact with SNS 210. For example, web client 205 may access the services of SNS 210 through another server, which may have a direct or indirect connection to web server 260.

As those skilled in the art will appreciate, web client 205, and/or wireless device 285, and/or any other known method and/or device configured to communicate over an electronic network, may each include an operating system (e.g., WINDOWS NT, 95/98/2000/Vista, OS2, UNIX, LINUX, SOLARIS, MAC OS, etc.) as well as various conventional support software and drivers typically associated with computers. A connecting device may include any suitable personal computer, network computer, workstation, minicomputer, mainframe or the like. In an exemplary embodiment, access is through a network or the Internet through a commercially available web-browser software package as described above.

Web client 205, and/or wireless device 285, and/or any other known method and/or device configured to communicate over an electronic network, may each be independently, separately or collectively suitably coupled to the network via data links which includes, for example, a connection to an Internet Service Provider (ISP) as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The invention contemplates uses in association with web services, utility computing, pervasive and individualized computing, security and identity solutions, autonomic computing, commodity computing, mobility and wireless solutions, open source, service oriented architecture, biometrics, grid computing and/or mesh computing.

Web server 260 may include any hardware and/or software suitably configured to facilitate communications using a wireless device 285. Further, web server 260 may be configured to transmit data to a connecting device within markup language documents. Communications originating from a connecting user 200 may pass through a firewall 215 before being received and processed at web server 260. As used herein, “transmit” may include sending electronic data from one system component to another over a network connection. Additionally, as used herein, “data” may include encompassing information such as commands, queries, files, data for storage, and the like in digital or any other form. Web server 260 may provide a suitable web site or other Internet-based graphical user interface, which is accessible by user 200, or any other authorized third party. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, ORACLE, SYBASE, INFORMIX MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL and an IP address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Router 270 comprises any hardware and/or software suitably configured to direct network traffic to the appropriate user 200 (e.g. wireless device 285). Specifically, router 270 operates to determine the next network point to which a data packet (request) should be forwarded in order to reach its destination. Router 270 communicates with at least two networks (e.g., WAN and wireless network) and determines which way to send each data packet based on the state of the networks it is connected to. Router 270 creates and maintains information relating to available routes and uses this information to determine the best route for a given data packet.

Data that is transmitted to or received from router 270 may pass through a firewall 215. In one embodiment, firewall 215 comprises any hardware and/or software suitably configured to protect SNS 210 from users of other networks. Firewall 215 may reside in varying configurations including Stateful Inspection, Proxy based and Packet Filtering among others. Firewall 215 may be integrated as software within web server 260, any other SNS 210 component, or may reside within another computing device or may take the form of a standalone hardware component.

In one embodiment, applications server 255 includes any hardware and/or software suitably configured to serve applications and data to a connected device. Like web server 260, applications server 255 may communicate with any number of other servers, databases and/or components through any means discussed herein or known in the art. Further, applications server 255 may serve as a conduit between a connecting device and SNS utility 250. Web server 260 may interface with applications server 255 through any means discussed herein or known in the art including a LAN/WAN, for example. Application server 255 may further directly and or indirectly interact with authentication server 265, user database 240, utilities database 255, messaging gateway 275, router 270 or any other SNS 210 component in response to requests from web client 205, and/or wireless device 285 and/or any other known method and/or device configured to communicate over an electronic network.

In one embodiment, SNS utilities 250 comprises a scheduling program which includes any hardware and/or software suitably configured to provide event scheduling and maintenance tasks through interaction with the various SNS 210 components. The scheduling program may comprise any number of software procedures and functions providing database access for the purposes of, for example, retrieving activities information, retrieving calendar entries, retrieving advertising information, creating invitations, creating announcements, saving event information, maintaining participant data, processing payments, and the like. In one embodiment, a scheduling program manages synchronization procedures between activities database and a calendaring system of user 200. Such calendaring systems may include, for example, Microsoft Outlook™, Lotus Notes™, Palm™, Blackberry™, etc.

SNS 210 may further include a report engine (not shown). Report engine includes any hardware and/or software suitably configured to produce reports from information stored in one or more databases. Report engines are commercially available and known in the art. Report engine provides, for example, printed reports, web access to reports, graphs, real-time information, raw data, batch information and/or the like. Report engine may be implemented through commercially available hardware and/or software, through custom hardware and/or software components, or through a combination thereof. Further, report engine may reside as a standalone system within SNS 210 or as a component of web server 260. The reports may include the attendees or non-attendees at certain activities and other statics using the codats stored in the SNS database 245.

To control access to web server 260 or any other component of the invention, web server 260 may invoke authentication server 255 in response to submission of authentication credentials received at web server 260. In one embodiment, authentication server 255 includes any hardware and/or software suitably configured to receive authentication credentials, encrypt and decrypt credentials, authenticate credentials, and/or grant access rights according to pre-defined permissions attached to the credentials. Based on permissions granted to user 200, SNS utilities 250 may manage access to other SNS 210 internal and/or external systems. Access to such systems may be necessary in order to allow user 200 to participate with the various aspects of the invention as disclosed in greater detail herein.

Authentication server 255 may grant varying degrees of application and data level access based on user information stored within user database 240. In one embodiment, authentication server 265 may be accessed by SNS utilities 250 in order to validate signals received by messaging gateway 275 from a wireless network 280.

As used herein, wireless network 280 may comprise any number of computing systems, relays, switches, radio towers, and satellites in order to provide wireless communications between any number of subscribing members. Those skilled in the art will appreciate that such systems are well known, and variations and advancements to the underlying technologies do not limit the scope of the invention. The invention contemplates that such networks may include, for example, land based RF transponders and satellites in low earth orbit to provide voice and data transmissions between a number of both stationary and portable devices.

In one embodiment, the various databases disclosed herein (e.g., user database 240 and SNS database 245) include any hardware and/or software suitably configured to facilitate storing authentication and/or privilege information relating to users. One skilled in the art will appreciate that the invention may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first type, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the invention by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the invention, the data can be stored without regard to a common format. However, in one exemplary embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations is further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to create, update, delete or augment the data in accordance with the header or trailer. The invention may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the invention may consist of any combination thereof at a single location or at multiple locations, wherein each database or system includes any of various suitable security features, such as firewalls, access codes, encryption, decryption, compression, decompression, and/or the like.

The invention may be described herein in terms of functional block components, screen shots, optional selections and various processing steps. It should be appreciated that such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, the software elements of the invention may be implemented with any programming or scripting language such as C, C++, JAVA, COBOL, assembler, PERL, Visual Basic, SQL Stored Procedures, extensible markup language (XML), with the various algorithms being implemented with any combination of data structures, objects, processes, routines or other programming elements. Further, it should be noted that the invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The software elements of the present invention may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

The present invention includes SNS 210 in networked communication with an SNS terminal (connection device). In one embodiment, a SNS terminal connects directly to SNS 210. In another embodiment, a SNS terminal connects to one or more servers, which in turn, connects to SNS 210. A personalized user interface provides a menu-based system, which is navigable using a mouse, a touch screen monitor or other electronic navigational instrument. In one embodiment, the user interface is coupled to a one or more servers, for example, through a wireless network 280, through the Internet, through a local area network, through a local intranet, though telephone lines, or any other communication or network discussed herein or later developed.

According to an exemplary embodiment of the invention includes an SNS terminal. An SNS terminal can be a web client 205, and/or a wireless device 285, and/or any other known method and/or device configured to communicate over an electronic network according to the various embodiments of the invention. In one embodiment, the SNS terminal user interface requires a unique user ID and/or password and/or additional personal identification information to access the network. In a further embodiment of the invention, the SNS terminal user interface may provide an access point for alternative positive identification, such as a retinal scanner, a fingerprint scanner, a magnetic card reader, a Radio Frequency Identification (“RFID”) tag reader, or other biometric scanners known in the art or later developed.

In yet another embodiment, any component of the system may be configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

The user interface may display and/or synchronize a user's SNS terminal information with SNS database information. For example, a user's SNS terminal calendar, messaging, email, lists, etc. may be synchronized with external scheduling software (i.e., Microsoft Outlook or Lotus Notes) or other SNS utilities 255. In an exemplary embodiment, the user interface displays a search dialogue for new users. The search dialogue allows the user to search the SNS database 245 for other users, spheres, interests, groups, activities and/or events scheduled in specific geographical regions. The SNS database 245 may also include information on popular activities, interests, ideas, etc. chosen by other users on the network, thus facilitating appropriate choices for activities that would interest larger numbers of users. According to other embodiments, the databases may comprise interests, ideas, groups, products, places and/or events in any number of pre-existing or custom created databases.

The user interface also provides, in one embodiment, an opportunity to display ambient advertising or other content. In conjunction with the advertising or other content, a particular brand, product and/or service is recommended to a user. A further embodiment of the invention provides a portal for users to purchase, for example, theater tickets, sporting event tickets, gifts, etc.

According to an exemplary embodiment, the SNS terminal user interface communicates with SNS database 245 and/or SNS utilities 250. SNS utilities 250 communicates with the Internet, a local area network, a telecommunications network, a wireless network, a satellite communications network, a community intranet, or any other networked discussed herein, such that information is transmitted between any of the user interfaces. SNS 210 further provides automatic product updates, user updates, activity updates and the like.

Additionally, the SNS 210 hosts databases, as discussed above, such as a database of all users on all SNS terminal location servers, a database of all information on all servers, a database of all SNS utilities 250, a database of all items to be sold by third parties, a secure database of all customer identification information, comprising financial account number for use in consumer transactions on the user interface. The main network server also hosts web sites which enable, for example, users and administrators to access various types of information and maintain the databases.

In an exemplary embodiment of the invention, each SNS terminal user interface communicates with SNS 210 via one or more servers. In various embodiments, the servers perform one or more of the following functions: communicates with the Internet, a local area network, a telecommunications network, a wireless network, a satellite network, a community intranet, etc.; receives product, user, activity, etc. updates from SNS 210; update SNS 210 databases (e.g., user database 240 and activities database 255) with new user information and/or activity information; receives updates for and updates software for connected SNS terminal devices; hosts a plurality of databases, for example, a database of approved users, a database or rejected users, a database of all items that are sold or offered for sale, etc.

In an exemplary embodiment, when not in use, the SNS terminal device displays either ambient advertising selected by the SNS 210 based on, for example, the users prior activity selections or scheduled merchant requests.

After successful log-in to the user interface 745, according to an exemplary embodiment, a question based menu system is displayed allowing a user to perform one or more functions. For example, user 200 may join a previously suggested sphere or activity that may include interests, ideas, and/or events, etc., suggested by other SNS terminal users. The user database 240 and SNS database are updated according the action of the user 200.

The SNS 210 allows users to create their own content (spheres and/or sub-spheres), to decide what content to share to and to whom, automatically monitors users activities to make specialist suggestions for new content, to join other user-created spheres, participate in events and contests, etc.

The SNS 210 may automatically suggest to users particular spheres (e.g., activities, interests, ideas, spheres, etc.), based on one or more of user's 200 inputs. In certain embodiments, the SNS terminal may suggest a random spheres (e.g., activity, sphere, product, contest, etc.) not based on prior inputs into the SNS 210 to cause the user to experience something new and different if the user has specifically allowed this functionality or if the functionality is under a default setting.

In another embodiment, the user interface generates and maintains a database of SNS terminal lists. Users may create lists (e.g., “My Favs” sphere) of other individual users (individual spheres) having similar (or different) interests, ideas, hobbies, etc. Any number of lists and/or spheres are created by any given user 200 within potential restrictions based on age, content, geographical limitations, etc. These lists and/or spheres may be used to limit the number of people who can see the lists, content, and/or events, etc.

In still another embodiment, the user interface 304 provides event and/or activity notifications. The SNS 210 updates users 200 of upcoming events via email, text message, voice mail or some other medium. This functionality is based on an individual user's pre-selected preferences and/or pre-selected preferences. Notifications are also sent if there is a change to the originally selected event and/or activity. SNS 210 may synchronize user's 200 pre-existing, external meeting scheduling software (e.g., Microsoft Outlook or Lotus Notes, for example) with the SNS terminal and notify user 200 of potential schedule conflicts.

According to a further embodiment, the user interface provides financial services in conjunction with the location server and SNS 210. The SNS terminal system may store users' bank account or credit card information including account numbers allowing the users to purchase products or make arrangements directly through the system. In conjunction with this functionality, the SNS terminal system allows users to also search through products, tickets, food items or other items to purchase or order through predetermined online retailers.

In conjunction with the financial services, an exemplary embodiment provides a philanthropic program, incentive program, and the like for users of the SNS terminal network. Users may select one or more charity organizations to donate a percentage of subscription fees paid by the users for accessing the SNS 210. In addition, users may participate in contests for prizes and/or educational scholarships.

In order to maintain safety, the user interface in conjunction with the SNS 210 may perform background checks on new users and periodically run background checks on current users. Users could be screened through a background checking service to determine if they are “safe” users. For example, the system may interface with or obtain data from criminal records, employment or business data, credit checks, civil litigation checks, other memberships, etc.

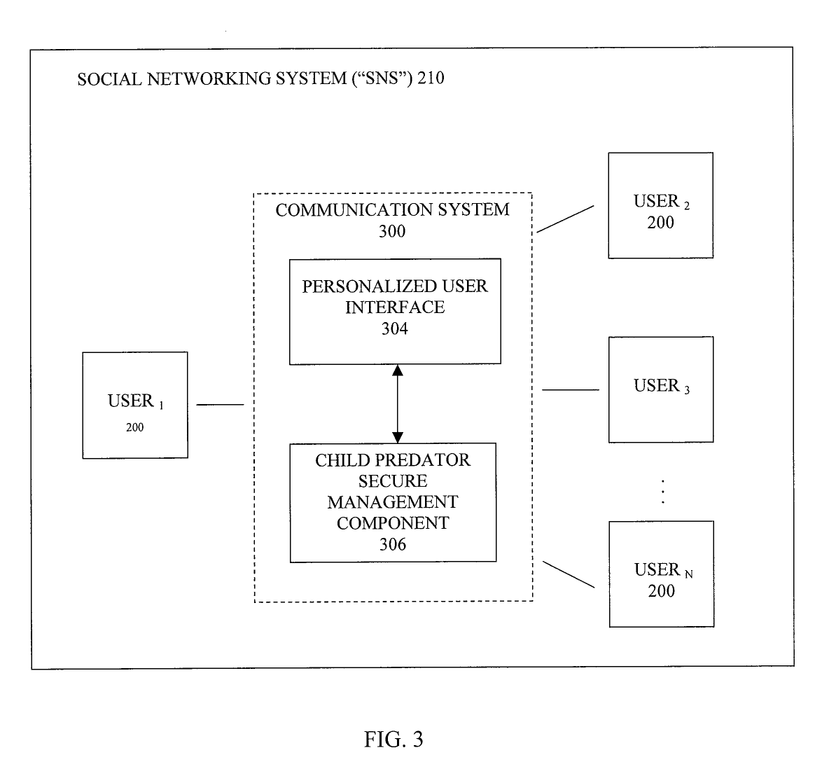

With reference to FIG. 3, SNS 210 performs background checks on new users to determine if they are safe users using a child predator secure management component 306. The personalized user interface 304 interacts with the child predator secure management component 306 to monitor users' 200 activity and detect behavior that is indicative of child predator conduct.

The SNS 210 and child predator secure management component 306 function together to keep ineligible users (too young or too old) from registering and using SNS 210. As part of this function, SNS 210 and/or the child predator secure management component 306 requires a unique user ID and/or password and/or additional personal identification information to register with SNS 210 and access the network. Personal identification information may include identifiers such as credit card information, social security information, and/or date of birth, etc. 700. Personal identification may also include biometric devices such as retinal scanner, a fingerprint scanner, a magnetic card reader, a Radio Frequency Identification (“RFID”) tag reader, or other biometric scanners known in the art or later developed 700.

With reference to FIG. 4, a personalized user interface 304 enables user 200 to manage their personal social activities within a social network. The interface may be presented in relation to the type of device used to access and interact with SNS 210. For example, if the connecting device is a kiosk, the interface may include large interface elements to enable user 200 greater control through a touch-screen. However, if the connecting device is a cellular telephone or personal digital assistant, interface elements may be configured to enable larger amounts of data to be viewable from a small LCD screen, or the interface may be divided between two or more specific interfaces.

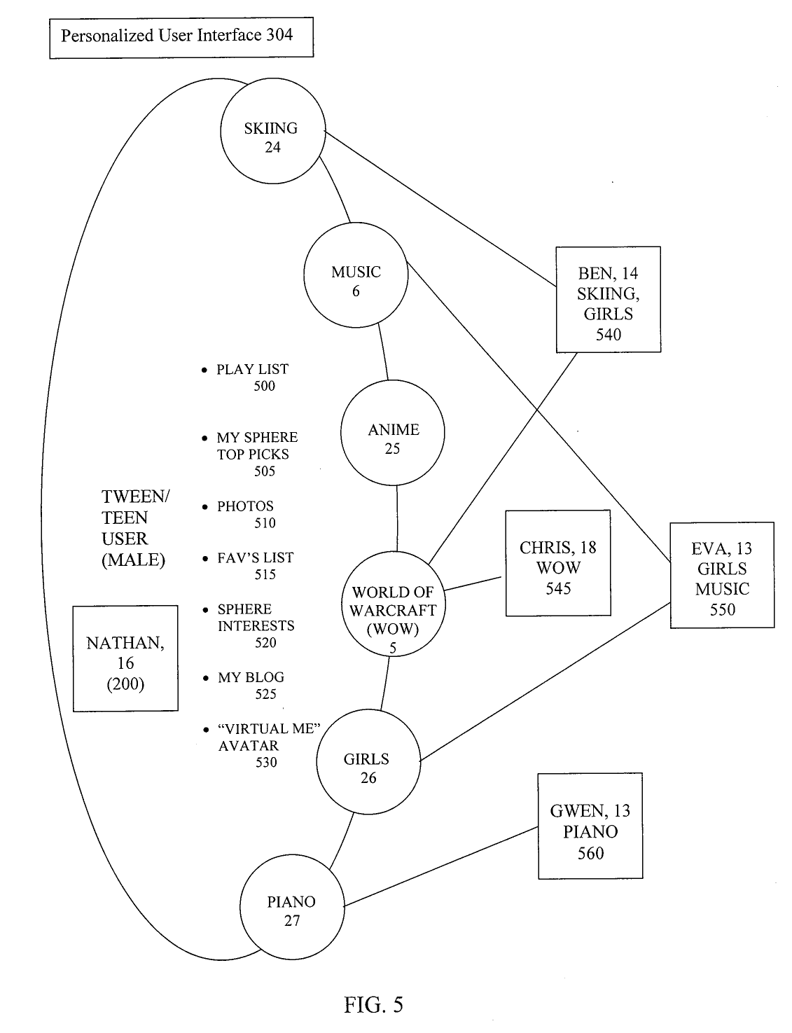

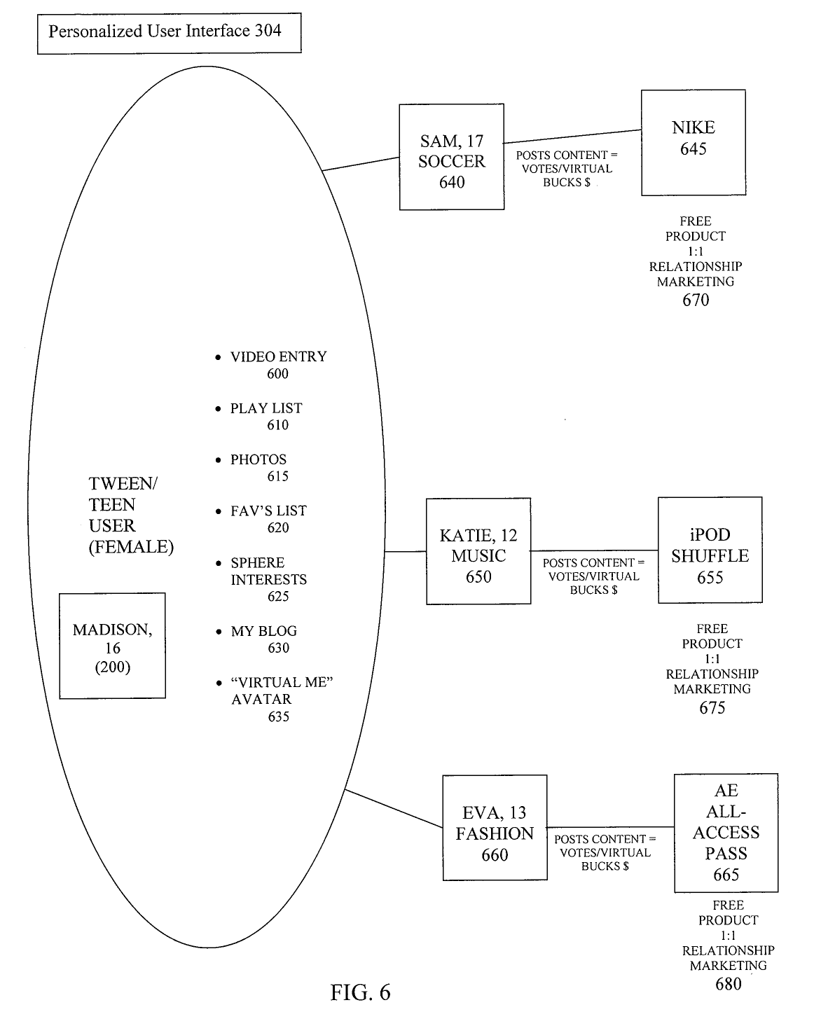

The personalized user interface 304 may include a unique greeting to ensure user 200 that he/she is viewing the proper personalized user interface 304. Moreover, the personalized user interface 304 may include an electronically linked text or graphic to identify and connect to a specific social network sphere, e.g. 1-23. (See also, FIG. 5, 24-33 and 500-560; FIG. 6, 600-665.)

The SNS 210 uses a collaborative filtering algorithm (see, e.g., Daniel Lemire, Anan Maclachlam, Slope One Predictors for Online Rating-Based Collaborative Filtering, In SIAM Data Mining (SDM '05), Newport Beach, Calif., Apr. 21-23, 2005) to transmit to the personalized user interface 304 spheres e.g., music, TV shows, movies/film, romance/dating/relationships, sports, online games, art, photography, fashion, computers 8: technology, video creation, fitness, travel, meeting other boys/girls, weather updates, directions to events, sale of complementary products, ideas, groups, interests, chat rooms, lists, products, services, etc. for the user 200 to investigate and integrate into his/her personalized user interface, based on the user's 200 prior input and activity within the SNS 210. Other algorithms or technology may be utilized to achieve matching scenarios for users based on interests and prior online conduct accessible to SNS 210.

The SNS 210 may allow authorized third party retailers, organizations, educational institutions, etc., full or limited access to the SNS 210 database, or a component thereof, to directly access users 200 to allow a 1:1 marketing ratio between merchant and user using the collaborative filtering algorithm.

Because the social network groups individuals into spheres of like, interests, ideas, gender, age, etc., personalized user interface 304 but may further include additional information and electronic links to enable businesses to closely target their prime demographic by selecting specific networks to place advertising.

SNS 210 may enable users 200 to schedule events with other users 200 or authorized third parties using an automated calendaring component. For example, a university may schedule an in person or virtual campus tour with users. When such an event is scheduled and the user is invited to such event, it will appear as a pending invitation within the personalized user interface 304.

With reference to FIG. 5, an embodiment is depicted of the SNS 210 wherein user 200 is identified as a teenage boy (16 years old) with a variety of interests 500-530 connected and/or displayed on his personalized user interface 304.

User 200 may connect to other user spheres 24, 6, 25, 5 26, 27, having similar interest through electronic links on the personalized user interface 304.

The SNS 210 in concert with the functions of its components and the personalized user interface 304 and the databases contained therein (e.g., SNS database 245 and user database 240) may provide automatic access to individual users 30-33 or user spheres with particularly identified interests similar to the SNS terminal user 200.

With reference to FIG. 6, an embodiment is depicted of the SNS 210 wherein the user 200 is identified as a teenage girl (16 years old) with a variety of interests 600-665, connected and/or displayed on her personalized user interface 304.

User 200 may connect to other users 640, 650, 660, having similar interest through electronic links on the personalized user interface 304.

Users may also participate in third party vendor sponsored events, contests and/or activities relating to the same identified interests 645, 675, 665. Users may also earn, acquire, accumulate, etc. “virtual buck” to “spend” on third-party products and/or services 670, 675, 680. Users may earn, acquire, accumulate, etc. “virtual bucks” by: becoming “experts” in a sphere category or sphere subcategory that is part of the SNS 210 or any of its components (e.g. SNS utility 255); by posting blogs; creating sphere categories and/or subcategories; by providing content in a sphere category or subcategory; by being winning votes from other users for posted content, etc.

Users may also use “virtual bucks” to purchase virtual items for their personalized avatars 635.

The SNS 210 in concert with the functions of its components and the personalized user interface 304 and the databases contained therein (e.g., SNS database 245 and user database 240) can provide approved third party vendors, retailers, organizations, institutions, etc. direct and individual (1:1) access to individual users with particularly identified interests 645, 655, 665 for the sale, promotion, research, etc. of commercial and non-commercial products and services.

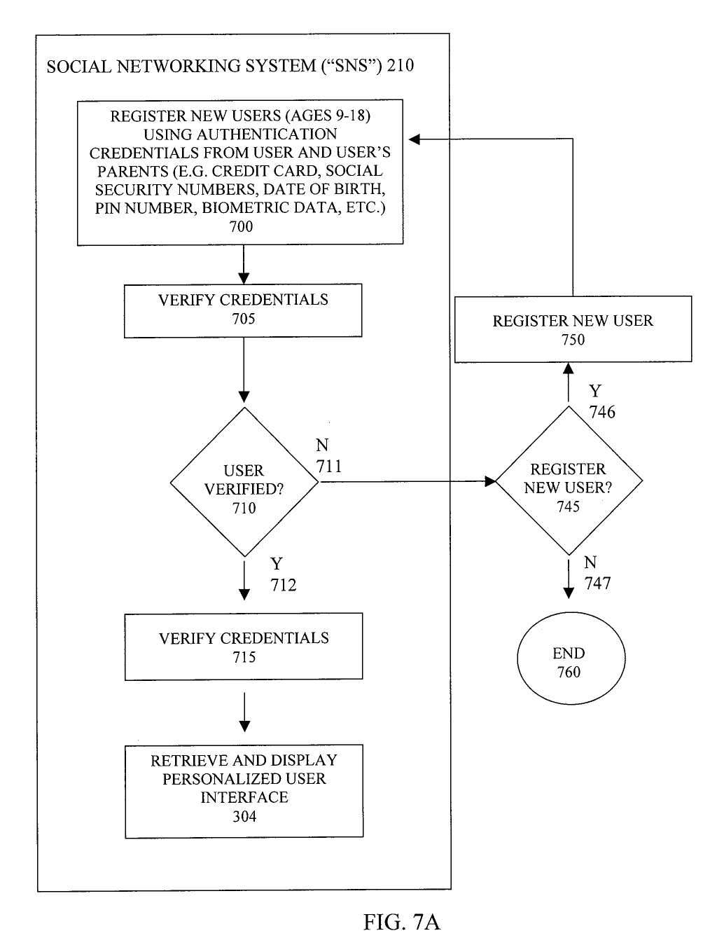

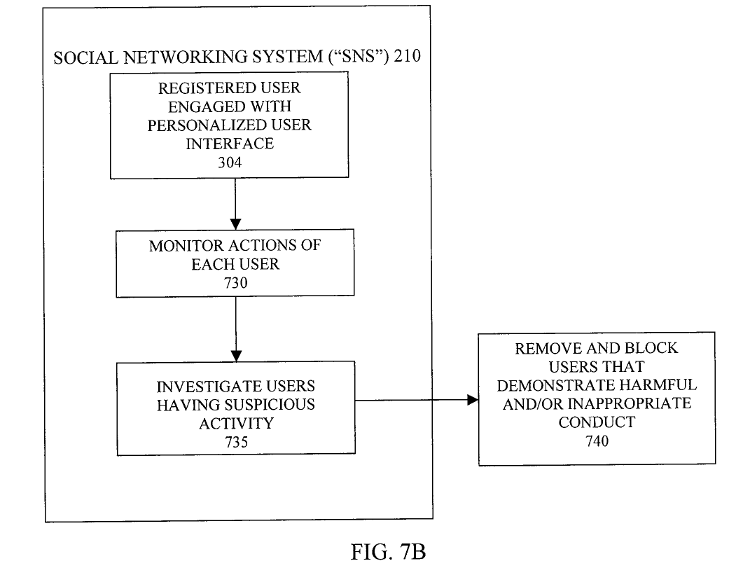

With reference to FIG. 7A, users 200 may interact with a SNS terminal interface 400 to perform a variety of functions described herein. User 200 enters unique authentication credentials into the SNS terminal interface 700. Practitioners will appreciate that such authentication credentials may comprise a user identifier, password, PIN, smart card radio frequency device, biometric read, or any combination thereof 700. Authentication credentials may be entered into a keyboard attached to the SNS terminal, entered into a touch screen keyboard, entered by way of an RF reader, smartcard reader, biometric reader, and the like.

Authentication credentials are transmitted from the SNS terminal to SNS 210 where they may be received and processed 705 by authentication server 265 or other server or application. Authentication server 265, other server or application, issues a query against user database 240 to verify the authentication credentials against stored records for registered users 710. If the authentication credentials are not verified 711, then user 200 is notified via SNS terminal and is prompted to register as a new user 745. If user 200 does not choose to register as a new user 747, the authentication process ends 760. However, if user 200 selects an option to register with SNS 210 (746), the user 200 is presented with a registration form 750. Any other step or component of known online registration processes may also be included.

If the authentication credentials for user 200 are verified 712, then SNS 210 verifies user 200 identity 715. Various technologies and methods may be implemented in order to identify a user's identity including, for example, a terminal identifier, a client identifier, personal information, and the like.

If user 200 attempts to access SNS 210 and is unauthorized or is not affiliated with the SNS 210, then SNS 210 and/or a component thereof transmits a message to the SNS terminal notifying user 200 that access to the SNS 210 is not authorized. Web server 260 aborts the network session and the process ends 760. If the user 200 or affiliation is verified, then SNS utilities 255 is invoked to retrieve the user's 200 personalized user interface 400. Personalized information and data includes information all electronic links connected to the personalized user interface 400 previously selected and/or saved.

With reference to FIG. 7B, once a registered user 725 logs into the SNS 210 the SNS 210 implements algorithms and computational tools to monitor the actions of each registered and active user 730.

If the SNS 210 and/or any component thereof detects improper, inappropriate or other conduct that falls within parameters defining a person with criminal, pedophiliac or other conduct characterized to be a risk to children using the SNS 210, the SNS 210 identifies the suspicious user and transmits a warning, notification or other alert to the SNS 210 administrators and/or appropriate personnel. The SNS 210 then advises the administrators and/or appropriate personnel of the conduct observed and prompts further investigation of the suspicious user 735. The investigation may constitute further electronic monitoring and/or a full investigation of the suspicious user.

If the identified suspicious user poses a risk, substantial or otherwise, as determined by the SNS 210 administrators and/or appropriate personnel, the suspicious user is removed from having access to the SNS 210 and blocked from further attempts to become a registered user 740.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

What is claimed is:

1. A method for managing an online social network, the method comprising:
establishing criteria for membership in a social network;
receiving a request to participate in the social network;
obtaining information about the requester;
verifying the actual identify of the requester; and
determining the eligibility of the requestor to participate in the social network based on the established criteria.

2. The method of claim 1 wherein the established criteria is based on at least one of:
geographic area, age, gender, hobby, interest, relationship status, family status, profession, memberships, education, financial status, race, religion, and event type.

3. The method of claim 2 wherein the established criteria is an age range.

4. The method of claim 3 wherein the age range is restricted to youth.

5. The method of claim 4 wherein the age range is nine to eighteen.

6. The method of claim 1 further comprising creating a profile for an eligible first user.

7. The method of claim 1 wherein the information obtained from the requestor is personal information.

8. The method of claim 1 wherein verifying the identify of the requester is based on presenting the requestor's information to an internet database.

9. The method of claim 1 wherein the request to participate in the social network further comprises a waiver of anonymity from the requester.

10. The method of claim 1 wherein the request to participate in the social network comprises a request for personal information about the requester.

11. The method of claim 10 wherein the personal information includes information from at least one category of: nationality, address, birth, financial, governmental, criminal, military, work and education.

12. The method of claim 1 wherein verifying the identify of the requester comprises first verifying the identity of a proxy requestor.

13. The method of claim 12 wherein the proxy is a parent or guardian of a minor requestor.

14. The method of claim 13 wherein further comprising verifying the identity of the proxy.

15. The method of claim 14 wherein the verified proxy verifies the identify of the minor requestor.

16. The method of claim 13 further comprising running the verified identity of at least one of the requestor and the proxy through a sex-offender database.

17. The method of claim 17 wherein the sex-offender database applies standards set forth by law for sex-offender screening.

18. The method of claim 18 wherein the sex-offender database qualifies as an FTC approved Safe Harbor provider under COPPA.

19. An online social network substantially limited to youth, the network comprising:
a) a computer database comprising data associating each user with information regarding age of the user;
b) a computer program for determining the eligibility of the user to participate in the social network based on established criteria;
c) means for collecting revenues based on access to the social network; and
d) a rewards program for returning a percentage of revenues to users as rewards.

20. The social network of claim 9 wherein the rewards are selected from the group consisting of funded internships, training, mentoring programs and scholarships.

21. The social network of claim 9 wherein the rewards are philanthropic donations selected by users.

22. The social network of claim 9 wherein revenues are membership fees collected from users.

23. The social network of claim 9 wherein revenues are advertising revenues collected from advertisers on said social network.
